(19) United States
(12) Patent Application Publication
(10) Pub. No.: US 2017/0108742 A1
(43) Pub. Date: Apr. 20, 2017

(54) FAST RESPONSE LIQUID CRYSTAL DISPLAY PANEL

(71) Applicant: Wuhan China Star Optoelectronics Technology Co., Ltd., Wuhan City (CN)

(72) Inventors: Xinhui Zhong, Wuhan City (CN); Hongqing Cui, Wuhan City (CN)

(21) Appl. No.: 15/009,798

(22) Filed: Jan. 28, 2016

(30) Foreign Application Priority Data
Oct. 16, 2015 (CN) 201510675941.X

(51) Int. Cl. G02F 1/1343; G02F 1/1335; G02F 1/1337

(52) U.S. Cl. CPC G02F 1/134309; G02F 1/1337; G02F 1/13439; G02F 1/133514; G02F 2001/133738

(57) ABSTRACT

A fast response liquid crystal display panel includes a first comb electrode arranged on a surface of an upper substrate that is adjacent to a liquid crystal layer and a second comb electrode arranged on a surface of a lower substrate that is adjacent to the liquid crystal layer. The first comb electrode includes a plurality of first elongate electrodes that are parallel to and spaced from each other and the second comb electrode includes a plurality of second elongate electrodes that are parallel to and spaced from each other. The plurality of first elongate electrodes and the plurality of second elongate electrodes are parallel to each other in a lengthwise direction thereof and are shifted with respect to each other and alternate with each other in a widthwise direction thereof. Application of electric voltage to the first comb electrode and the second comb electrode causes the liquid crystal molecules of the liquid crystal layer to undergo both splay deformation and twist deformation, increasing the deformation elastic constant of the liquid crystal molecules and making liquid crystal display panel speeding up the response time to perform a fast response.

### BACKGROUND OF THE INVENTION

### 1. Field of the Invention

The present invention relates to the field of display technology, and in particular to a fast response liquid crystal display panel.

### 2. The Related Arts

Thin-film transistor liquid crystal displays (TFT-LCDs) have recently been developed fast and used widely. A liquid crystal display panel is the most important component of the TFT LCD. A liquid crystal display panel is often made up of a color filter (CF) substrate, a thin-film transistor (TFT) array substrate, and a liquid crystal layer arranged between the two substrates and the operation principle thereof is that a driving voltage is applied to the two glass substrates to control the rotation of liquid crystal molecules contained in the liquid crystal layer in order to refract out light from a backlight module to generate an image. According to the way that the liquid crystal is oriented, the liquid crystal display panels that are available in the mainstream market can be classified in several types: vertical alignment (VA) type, twisted nematic (TN) or super twisted nematic (STN) type, in-plane switching (IPS) type, and fringe field switching (FFS) type, among which the IPS and FFS type liquid crystal display panels are structured to have the liquid crystal molecules oriented parallel to the surfaces of the substrates so that the rotation of the liquid crystal molecules can be controlled by applying a horizontal electric field to the liquid crystal layer.

A number of parameters can be used to assess the performance of a liquid crystal display panel, including resolution, contrast, gamut, and response time, among which response time is the parameter that characterizes dynamic response performance of liquid crystal and is the time interval necessary for a process of switching brightness of the panel and directly affects image displaying, particularly the quality of dynamic displaying of image. Generally, the faster the response time is, the higher the maximum image refresh frequency that the liquid crystal display panel may achieve would be, the smaller the extent of streaking would be, and the clearer a displayed dynamic image that is in a high speed movement would be.

As shown in FIG. 1, a response time curve of a liquid crystal display panel is illustrated, in which the ordinate indicates brightness and the abscissa is time. The response time includes the rise time of brightness, Ton, and the fall time of brightness, Toff. The rise time of brightness, Ton, is the time interval required for brightness to vary from 10% to 90%, and the fall time of brightness, Toff, is the time interval required for brightness to vary from 90% to 10%.

Generally, the brightness rise time, Ton, and the brightness fall time, Toff, for an IPS or FFS type liquid crystal display panel can be respectively represented by formulas (1) and (2):

Ton=r₁/(εₐE²−(π²/d²)k₁) (1)

Toff=r₁d²/(π²k₁) (2)

where r₁ indicates rotational viscosity of liquid crystal material, εₐ is dielectric constant of the liquid crystal material, E is the magnitude of electric field, d is the thickness of the liquid crystal layer, and k1 is deformation elastic constant of the liquid crystal molecules. It can be seen from formulas (1) and (2) that by reducing the rotational viscosity r₁ of the liquid crystal material or increasing the deformation elastic coefficient k₁ of the liquid crystal molecules, the response time of the liquid crystal display panel can be sped up.

Elastic deformation of liquid crystal can be separated into three types of deformation: splay, twist, and bend that are respectively illustrated in FIGS. 2a, 2b, and 2c. With the elastic constant for splay deformation of liquid crystal being defined as k₁₁, the elastic constant for twist deformation of liquid crystal being defined as k₂₂, and the elastic constant for bend deformation of liquid crystal being defined as k₃₃, the elastic constants of these three types of deformation demonstrate the following relationship, according to the values thereof, k₃₃>k₁₁>k₂₂.

Currently, an IPS or FFS type liquid crystal display panel is often referred to as a “hard screen” due to the better view angle performance and being not easy to induce variation of brightness and color when the panel is pressed down, and is widely used in products, including mobile phones and pad, that include a touch control function, to show an excellent effect of displaying. However, the IPS and FFS type liquid crystal displays suffer an issue of response being not fast enough. Particularly, for use in a low temperature cold environment, this issue gets even significant and may readily cause a poor effect of displayed Images and streaking for dynamic displaying.

### SUMMARY OF THE INVENTION

An object of the present invention is to provide a liquid crystal display panel, which speeds up the response time to achieve fast response to thereby overcome the issue that the response time of the IPS and FFS types of liquid crystal display panel is not fast enough to provide them with a better effect of displaying a dynamic image.

To achieve the above object, the present invention provides a fast response liquid crystal display panel, which comprises: an upper substrate, a lower substrate arranged opposite to the upper substrate, a liquid crystal layer interposed between the upper substrate and the lower substrate, a first comb electrode arranged on a surface of the upper substrate that is adjacent to the liquid crystal layer, a first alignment film covering the upper substrate and the first comb electrode, a second comb electrode arranged on a surface of the lower substrate that is adjacent to the liquid crystal layer, and a second alignment film covering the lower substrate and the second comb electrode;

the first comb electrode comprising a plurality of first elongate electrodes that are parallel to and spaced from each other, the second comb electrode comprising a plurality of second elongate electrodes that are parallel to and spaced from each other, the plurality of first elongate electrodes and the plurality of second elongate electrodes being parallel to each other in a lengthwise direction thereof and shifted with respect to each other and alternate with each other in a widthwise direction thereof;

the liquid crystal layer involving horizontal alignment.

The plurality of first elongate electrodes are arranged to equally spaced from each other and the plurality of second elongate electrodes are arranged to equally spaced from each other. A spacing distance between two adjacent ones of the first elongate electrodes is equal to a spacing distance between two adjacent ones of the second elongate electrodes. Spacing distances between adjacent ones of the first elongate electrodes and the second elongate electrodes that are shifted with respect to each other and alternate with each other in the widthwise direction of the plurality of first elongate electrodes and the plurality of second elongate electrodes are identical.

The plurality of first elongate electrodes and the plurality of second elongate electrodes both have a width of 1 μm-10 μm.

The spacing distance between two adjacent ones of the first elongate electrodes and the spacing distance between adjacent ones of the second elongate electrodes are both 2 μm-20 μm.

The widths of the plurality of first elongate electrodes and the plurality of second elongate electrodes are 2 μm-4 μm.

The spacing distance between two adjacent ones of the first elongate electrodes and the spacing distance between adjacent ones of the second elongate electrodes are 4 μm-10 μm.

The first comb electrode and the second comb electrode are made of indium tin oxide (ITO) or an electrically conductive metal.

One of the upper substrate and the lower substrate is a thin-film transistor (TFT) array substrate, which comprises gate lines, data lines, and TFTs, and the other one is a color filter (CF) substrate, which comprises a black matrix, a color filter, an over coat, and photo spacers.

The efficacy of the present invention is that the present invention provides a fast response liquid crystal display panel, which comprises a first comb electrode arranged on the surface of an upper substrate that is adjacent to a liquid crystal layer and a second comb electrode arranged on the surface of a lower substrate that is adjacent to the liquid crystal layer. The first comb electrode comprises a plurality of first elongate electrodes that are parallel to and spaced from each other and the second comb electrode comprises a plurality of second elongate electrodes that are parallel to and spaced from each other. The plurality of first elongate electrodes and the plurality of second elongate electrodes are parallel to each other in a lengthwise direction thereof and are shifted with respect to each other and alternate with each other in a widthwise direction thereof. Application of electric voltage to the first comb electrode and the second comb electrode causes the liquid crystal molecules of the liquid crystal layer to undergo both splay deformation and twist deformation, increasing the deformation elastic constant of the liquid crystal molecules and making liquid crystal display panel speeding up the response time to perform a fast response, thereby overcoming the issue that the response time of the IPS or FFS type liquid crystal display panel is not fast enough to provide a better effect of displaying dynamic images.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will become apparent from the following detailed description of an embodiment of the present invention, with reference to the attached drawings.

In the drawings:

FIG. 1 shows a response time curve for a liquid crystal display panel;

FIG. 2a is a schematic view illustrating splay deformation of liquid crystal molecules;

FIG. 2b is a schematic view illustrating twist deformation of liquid crystal molecules;

FIG. 2c is a schematic view illustrating bend deformation of liquid crystal molecules;

FIG. 3 is a cross-sectional view illustrating the structure of a fast response liquid crystal display panel according to the present invention;

FIG. 4 is a perspective view corresponding to FIG. 3 but with a first alignment film and a second alignment film omitted;

FIG. 5 is a schematic view illustrating simulation of a liquid crystal layer for the fast response liquid crystal display panel according to the present invention being applied with an electric voltage; and

FIG. 6 is a schematic view illustrating simulation of a liquid crystal layer for a conventional IPS or FFS liquid crystal display panel being applied with an electric voltage.

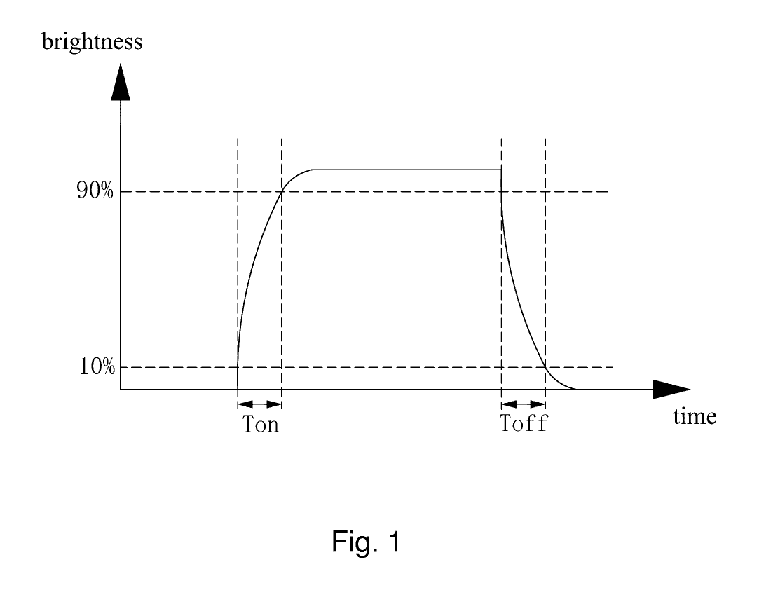

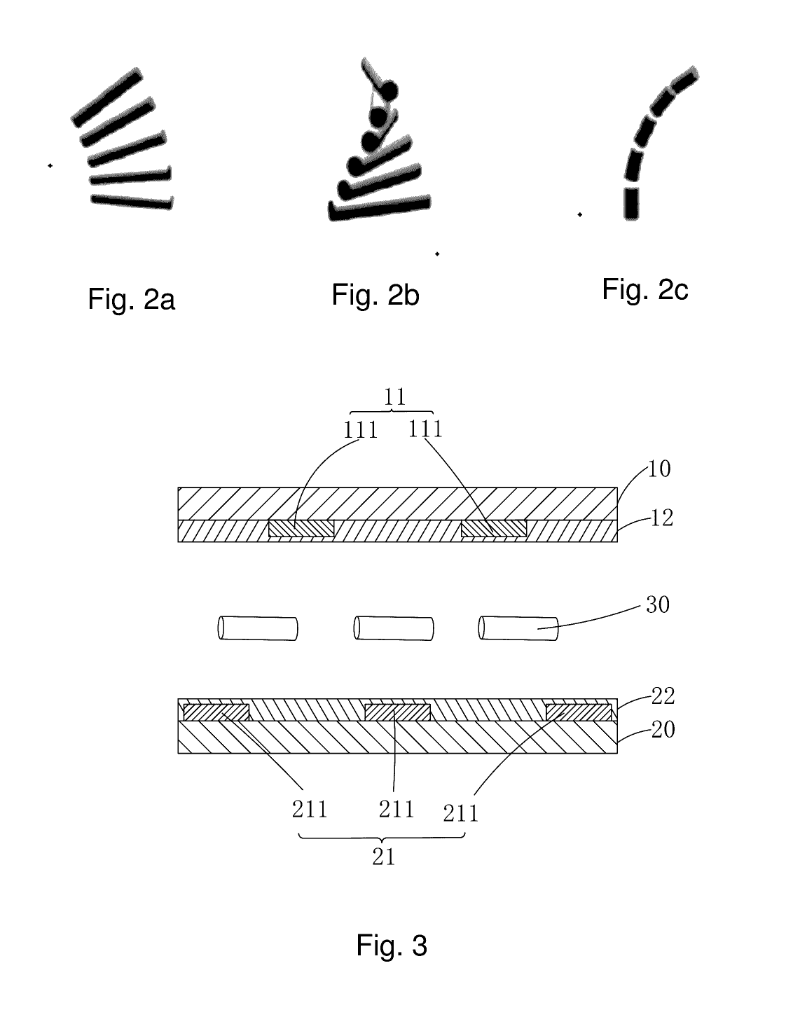

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

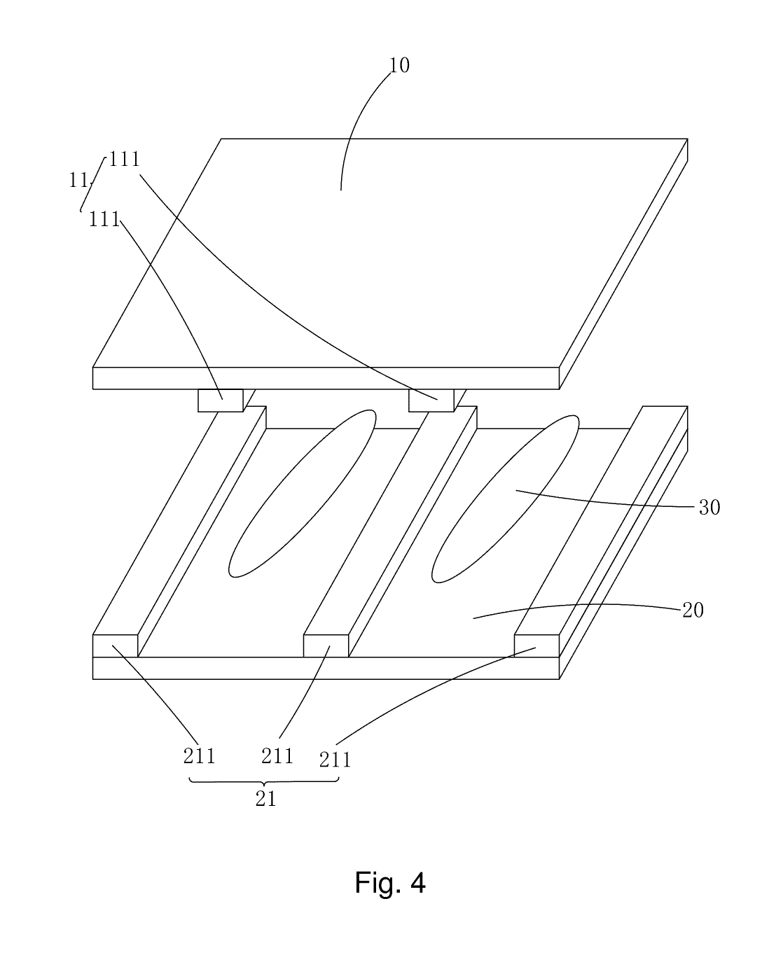

Referring collectively to FIGS. 3 and 4, the present invention provides a fast response liquid crystal display panel, which comprises an upper substrate 10, a lower substrate 20 that is arranged opposite to the upper substrate 10, a liquid crystal layer 30 interposed between the upper substrate 10 and the lower substrate 20, a first comb electrode 11 arranged on a surface of the upper substrate 10 that is adjacent to the liquid crystal layer 30, a first alignment film 12 covering the upper substrate 10 and the first comb electrode 11, a second comb electrode 21 arranged on a surface of the lower substrate 20 that is adjacent to the liquid crystal layer 30, and a second alignment film 22 covering the lower substrate 20 and the second comb electrode 21.

Specifically, one of the upper substrate 10 and the lower substrate 20 is a thin-film transistor (TFT) array substrate, which comprise gate lines, data lines, and TFTs and is similar to a TFT array substrate of a conventional IPS or FFS type liquid crystal display panel so that no further details will be provided; and the other one is a color filter (CF) substrate, which comprises a black matrix (BM), a color filter (CF), an over coat (OC), and photo spacers (PS) and is similar to a TFT array substrate of the conventional IPS or FFS type liquid crystal display panel so that no further details will be provided.

The liquid crystal layer 30 adopts horizontal alignment.

It is noted here that the first comb electrode 11 comprises a plurality of first elongate electrodes 111 that are parallel to and spaced from each other and the second comb electrode 21 comprises a plurality of second elongate electrodes 211 that are parallel to and spaced from each other. The plurality of first elongate electrodes 111 and the plurality of second elongate electrodes 211 are parallel to each other in a lengthwise direction thereof and are shifted with respect to each other and alternate with each other in a widthwise direction thereof.

Preferably, the plurality of first elongate electrodes 111 are arranged to equally spaced from each other and the plurality of second elongate electrodes 211 are arranged to equally spaced from each other. A spacing distance between two adjacent ones of the first elongate electrodes 111 is equal to a spacing distance between two adjacent ones of the second elongate electrodes 211 and spacing distances between adjacent ones of the first elongate electrodes 111 and the second elongate electrodes 211 that are shifted with respect to each other and alternate with each other in the widthwise direction of the plurality of first elongate electrodes 111 and the plurality of second elongate electrodes 211 are identical so that electric field established between the first comb electrode 11 and the second comb electrode 21 after the application of an electrical voltage is more consistent.

Further, the plurality of first elongate electrodes 111 and the plurality of second elongate electrodes 211 both have a width of 1 μm-10 μm, preferably 2 μm-4 μm; and the spacing distance between two adjacent ones of the first elongate electrodes 111 and the spacing distance between adjacent ones of the second elongate electrodes 211 are both 2 μm-20 μm, preferably 4 μm-10 μm.

The first comb electrode 11 and the second comb electrode 21 are both made of a material comprising an indium tin oxide (ITO) film or an electrically conductive metal.

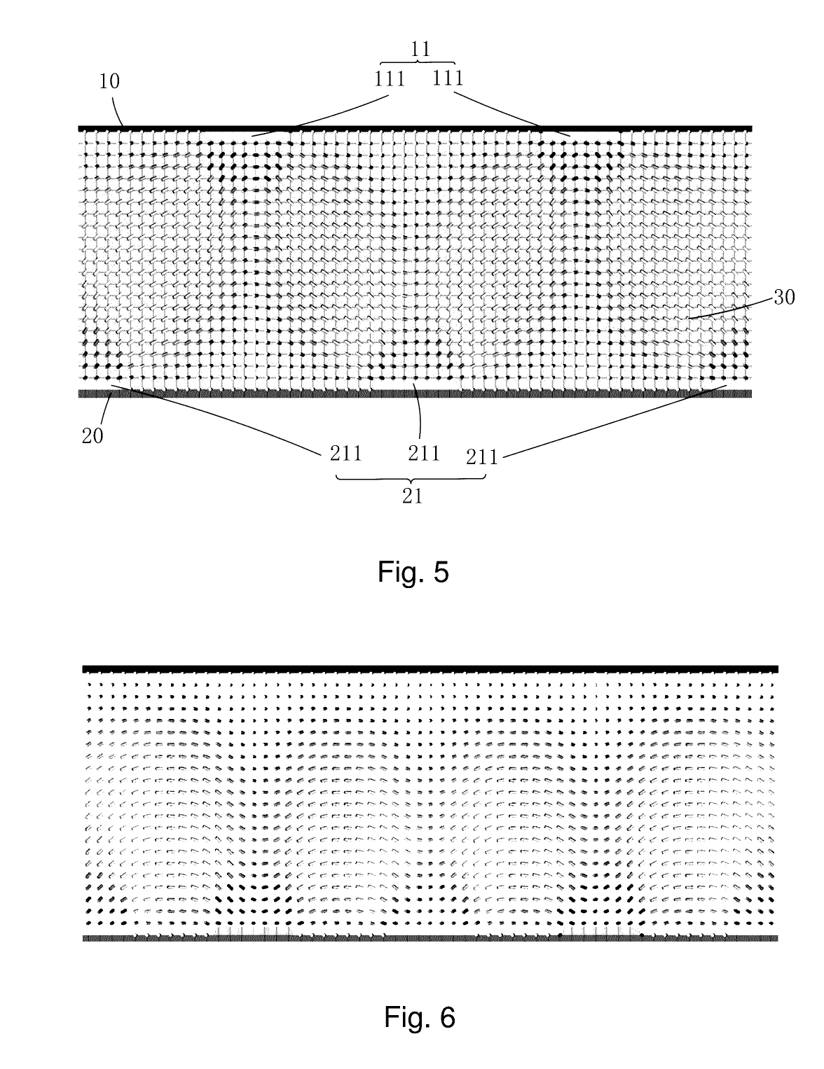

Reference being had to FIGS. 3, 4, and 5 collectively, when an electric voltage is applied to the first comb electrode 11 and the second comb electrode 21 of the fast response liquid crystal display panel according to the present invention, an electric field established between the first comb electrode 11 and the second comb electrode 21 makes liquid crystal molecules contained in the liquid crystal layer 30 generating in-plane rotation and also tilting so that under this condition, as shown in FIG. 5, the liquid crystal molecules generates both splay deformation and twist deformation. Correspondingly, the deformation elastic constant k₁ of the liquid crystal molecules is determined by both the elastic constant k₁₁ for splay deformation and the elastic constant k₂₂ for twist deformation. For a conventional IPS or FFS type liquid crystal display panel shown in FIG. 6, there is only one substrate is provided with a comb electrode so that when an electric voltage is applied to drive the liquid crystal layer, the liquid crystal molecules is only caused to generate in-plane rotation and thus only twist deformation is generated; correspondingly, the deformation elastic constant k₁ of the liquid crystal molecules is determined only by the elastic constant k₂₂ for twist deformation. It is also known that k₁₁>k₂₂, so that when the fast response liquid crystal display panel of the present invention is in operation to drive the liquid crystal layer 30, the deformation elastic constant k1 of the liquid crystal molecules could be made bigger. It can be known from calculation of the formula (2) for brightness fall time Toff that the brightness fall time Toff of the fast response liquid crystal display panel according to the present invention is shorter so that the response speed is faster.

Toff=r₁d²/(π²k₁) (2)

Comparison between simulations conducted with simulation software indicates that with the same thickness of the liquid crystal layer and the same width and spacing distance of the elongate electrodes, the brightness fall time Toff of the fast response liquid crystal display panel according to the present invention is 8.3 ms, while the brightness fall time Toff of the conventional IPS or FFS type liquid crystal display panel is 11.7 ms, the response time being sped up by around 30%, making the effect prominent.

In summary, the present invention provides a fast response liquid crystal display panel, which comprises a first comb electrode arranged on the surface of an upper substrate that is adjacent to a liquid crystal layer and a second comb electrode arranged on the surface of a lower substrate that is adjacent to the liquid crystal layer. The first comb electrode comprises a plurality of first elongate electrodes that are parallel to and spaced from each other and the second comb electrode comprises a plurality of second elongate electrodes that are parallel to and spaced from each other. The plurality of first elongate electrodes and the plurality of second elongate electrodes are parallel to each other in a lengthwise direction thereof and are shifted with respect to each other and alternate with each other in a widthwise direction thereof. Application of electric voltage to the first comb electrode and the second comb electrode causes the liquid crystal molecules of the liquid crystal layer to undergo both splay deformation and twist deformation, increasing the deformation elastic constant of the liquid crystal molecules and making liquid crystal display panel speeding up the response time to perform a fast response, thereby overcoming the issue that the response time of the IPS or FFS type liquid crystal display panel is not fast enough to provide a better effect of displaying dynamic images.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A fast response liquid crystal display panel, comprising: an upper substrate, a lower substrate arranged opposite to the upper substrate, a liquid crystal layer interposed between the upper substrate and the lower substrate, a first comb electrode arranged on a surface of the upper substrate that is adjacent to the liquid crystal layer, a first alignment film covering the upper substrate and the first comb electrode, a second comb electrode arranged on a surface of the lower substrate that is adjacent to the liquid crystal layer, and a second alignment film covering the lower substrate and the second comb electrode;
the first comb electrode comprising a plurality of first elongate electrodes that are parallel to and spaced from each other, the second comb electrode comprising a plurality of second elongate electrodes that are parallel to and spaced from each other, the plurality of first elongate electrodes and the plurality of second elongate electrodes being parallel to each other in a lengthwise direction thereof and shifted with respect to each other and alternate with each other in a widthwise direction thereof;
the liquid crystal layer involving horizontal alignment.

2. The fast response liquid crystal display panel as claimed in claim 1, wherein the plurality of first elongate electrodes are arranged to equally spaced from each other and the plurality of second elongate electrodes are arranged to equally spaced from each other, a spacing distance between two adjacent ones of the first elongate electrodes being equal to a spacing distance between two adjacent ones of the second elongate electrodes, spacing distances between adjacent ones of the first elongate electrodes and the second elongate electrodes that are shifted with respect to each other and alternate with each other in the widthwise direction of the plurality of first elongate electrodes and the plurality of second elongate electrodes being identical.

3. The fast response liquid crystal display panel as claimed in claim 2, wherein the plurality of first elongate electrodes and the plurality of second elongate electrodes both have a width of 1 μm-10 μm.

4. The fast response liquid crystal display panel as claimed in claim 2, wherein the spacing distance between two adjacent ones of the first elongate electrodes and the spacing distance between adjacent ones of the second elongate electrodes are both 2 μm-20 μm.

5. The fast response liquid crystal display panel as claimed in claim 3, wherein the widths of the plurality of first elongate electrodes and the plurality of second elongate electrodes are 2 μm-4 μm.

6. The fast response liquid crystal display panel as claimed in claim 4, wherein the spacing distance between two adjacent ones of the first elongate electrodes and the spacing distance between adjacent ones of the second elongate electrodes are 4 μm-10 μm.

7. The fast response liquid crystal display panel as claimed in claim 1, wherein the first comb electrode and the second comb electrode are made of indium tin oxide (ITO) or an electrically conductive metal.

8. The fast response liquid crystal display panel as claimed in claim 1, wherein one of the upper substrate and the lower substrate is a thin-film transistor (TFT) array substrate, which comprises gate lines, data lines, and TFTs, and the other one is a color filter (CF) substrate, which comprises a black matrix, a color filter, an over coat, and photo spacers.
